(19) United States
(12) Patent Application Publication
(10) Pub. No.: US 2014/0328484 A1
(43) Pub. Date: Nov. 6, 2014

(54) METHOD AND DEVICE FOR SYNCHRONIZING SOUND SOURCES

(71) Applicant: AWOX, Montpellier (FR)

(72) Inventors: Alain Molinie, Montpellier (FR); Eric Lavigne, Montpellier (FR); Vincent Leclaire, Montpellier (FR)

(73) Assignee: AWOX, Montpellier (FR)

(21) Appl. No.: 14/343,625

(22) PCT Filed: Sep. 7, 2012
(86) PCT No.: PCT/FR2012/052010

§ 371 Date: Jun. 4, 2014

(30) Foreign Application Priority Data
Sep. 7, 2011 (FR) 1157957

(51) Int. Cl. H04H 60/13; H04W 56/00; H04W 48/16

(52) U.S. Cl. CPC H04H 60/13; H04W 48/16; H04W 56/001
USPC 381/2

(57) ABSTRACT

The device for broadcasting sounds for playing an audio content coming from at least one audio content server includes: a base (220) for supplying electrical power to the device from a bulb socket, an electroacoustic transducer, a unit for discovering a network including at least the server and at least one other device for broadcasting sounds, and a unit for synchronizing the playing of sounds by the electroacoustic transducer and the playing of sounds by the other device. In embodiments, the device includes: a unit for exchanging messages with at least one other device for broadcasting sounds and a unit for selecting sound and/or light signals broadcast by the electroacoustic transducer, according to data received from at least one other device for broadcasting sounds. In embodiments, the selection unit is designed to select an audio channel according to at least one audio channel selected by another device for broadcasting sounds.

### TECHNICAL FIELD

The present invention concerns a method and a device for synchronizing sound sources. It applies, in particular, to the synchronization of sound broadcasters located remotely.

### PRIOR STATE OF THE ART

People have more and more digital audio media elements. It is now common to share this content over a domestic network utilizing the DLNA (acronym for Digital Living Network Alliance) standard.

However, in a domestic environment, more and more sound sources can be used to broadcast a digital audio media item residing on a storage device. For example, from a mobile telephone one may wish to trigger the playing of a shared media item by a computer over several loudspeakers distributed through different rooms in a home.

However, when one device triggers the playing of a single media item on two sound sources, the latter emitting the same sound or different channels representative of the same media item with a time offset; the quality perceived by the users is then lower.

There are products allowing several sound sources to be synchronized, but these products require either the use of proprietary (non-DLNA) network protocols, or the complete renewal of the DLNA system, e.g. purchasing new specialist DLNA software for sharing content on one's computer, or purchasing a specialist sharing device.

Lastly, coordinating the media diffusers requires an action by the user, which takes time and requires technical know-how that is often not fully understood.

### DESCRIPTION OF THE INVENTION

The present invention aims to remedy all or part of these drawbacks and, in particular, offer the coordination of several emitting sound sources from a device sharing its content with several diffusers, in particular sound and/or light renderers.

To this end, according to a first aspect, the present invention envisages a device for broadcasting sounds for playing an audio content coming from at least one audio content server; the device comprising:
a base for supplying electrical power to the device from a bulb socket,
an electroacoustic transducer,
a means of discovering a network comprising at least said server and at least one other device for broadcasting sounds and
a means of synchronizing the playing of sounds by said electroacoustic transducer and the playing of sounds by said other device.

Thanks to these provisions, the various sound sources are synchronized automatically, without requiring the user to perform any action other than plugging the device in an electric light bulb power supply socket.

According to a second aspect, the present invention envisages a device for broadcasting sound and/or light, the device comprising:
a base for supplying electrical power to the device from a bulb socket,
an electroacoustic transducer,
a means of exchanging messages with at least one other device for broadcasting sounds and
a means of selecting sound and/or light signals broadcast by said electroacoustic transducer, according to data received from at least one other device for broadcasting sounds.

Thanks to these provisions, the different sound sources are automatically coordinated, i.e. select a channel (right or left) of the audio content depending on the channel broadcast in addition or select a light intensity or a color of light emitted, depending on other light emissions, without requiring the user to perform any action other than plugging the device in an electric light bulb power supply socket.

According to a third aspect, the present invention envisages a device for broadcasting sounds for playing an audio content coming from at least one audio content server; the device comprising:
a base for supplying electrical power to the device from a bulb socket,
an electroacoustic transducer,
a means of declaring said device in wireless access point mode. It is recalled here that a wireless access point or “WAP” is a device that allows other devices to connect to a—generally wired—network using WiFi, Bluetooth or similar standards.

Thanks to these provisions, the device that is the subject of the invention makes it possible to constitute a network of devices.

According to a fourth aspect, the present invention envisages a device for synchronizing sound sources, for the playing of an audio content coming from at least one content storage system utilizing the DLNA standard, to form a DLNA server; the device comprising:
a master sound broadcasting system utilizing the DLNA standard to form a DLNA audio renderer,
at least one slave sound broadcasting system utilizing the DLNA standard to form a DLNA audio renderer,
a control system utilizing the DLNA standard to form a DLNA controller designed to:
   discover the audio content available on at least one DLNA server,
   configure at least one DLNA audio renderer and
   trigger the sending of content from a DLNA server to at least one DLNA audio renderer, using a data transfer protocol and a compressed data format.

In this device:
the master system comprises:
   a data transfer protocol decoder,
   an audio encoder, which encodes the decoded content found in a compressed audio format to an audio format with no compression and no header information,
   a module for transmitting the encoded content using a protocol allowing timing control of slave systems, and
the slave systems are designed to decode and broadcast the audio content received from the master system.

Thanks to these provisions, the time offsets between the signals broadcast by the DLNA renderers are synchronized to below the threshold of human perception. In particular, through the use of a RAW format for the audio data to be broadcast and the RTP timing control protocol, no variable delay can arise in the signal's decompression, or in the transmission over the network by the master system or by the slave systems. In addition, the device that is the subject of the present invention is an open system.

In embodiments, the device that is the subject of the present invention, according to either one of its aspects, comprises a means of communicating at least one IP Internet protocol address.

In embodiments, the device that is the subject of the present invention, according to either one of its aspects, comprises a means of receiving signals coming from a control point, as defined by the UPnP standard and constitutes a renderer as defined by this standard.

It is noted that a control point and a renderer are better known by the person skilled in the art as “control point” and “renderer”.

According to particular features, the data transfer protocol is the HTTP protocol.

According to particular features, the audio format with no compression and no header information is the RAW or PCM protocol.

According to particular features, the master system forms a gateway that acts as a server for the various renderers.

According to particular features, the transmission module is designed to carry out encoding using the RTP real time protocol.

According to particular features, the transmission module is designed to carry out encoding using the TCP transmission control protocol.

According to particular features, the master system is designed to broadcast the audio content simultaneously to the slave systems.

According to particular features, the device that is the subject of the invention comprises:
a light source base, referred to as “upstream”,
a light source powered by said base,
an electroacoustic transducer,
a means of receiving signals representative of a sound signal to be played by the loudspeaker, powered by said base, and
an amplifier powered by said base and designed to amplify the electrical signal supplied by the reception means so as to transmit an amplified signal to the electroacoustic transducer.

Thanks to these provisions, a discrete audio terminal coupled to a light point is utilized. One of its advantages is that light points are numerous, accessible and powered. In addition, the existing sockets of a home's lighting network can be used to create a network of distributed, powered loudspeakers with no additional wiring. It is thus possible from a computer or a mobile phone connected to the network, equipped with a controller utilizing the DLNA standard and UPnP protocol, to discover, as defined by the DLNA standard, each of the accessible devices that are the subjects of the present invention and to control them individually or, using a grouping system, to control them by zones, ensuring synchronization over each of the zones.

According to particular features, the device that is the subject of the invention comprises:
a light source base, referred to as “upstream”,
a light source powered by said base,
a means of receiving radio signals, powered by said base, designed to receive radio signals emitted by at least one first computer system, and
a means of emitting radio signals, powered by said base and designed to retransmit radio signals received by the reception means towards a second computer system so as to extend the radio communications range between the first computer system and the second computer system.

Thanks to these provisions, a discrete repeater coupled to a light point is realized. One of its advantages is that light points are numerous, accessible and powered. Thanks to the utilization of the present invention, the existing sockets of a home or work-place lighting network can be used to create an extended network equipped with several distributed, powered repeaters with no additional wiring compared to the lighting network. It should be noted that “computer system” means any system equipped with a memory storing at least one program and a central processing unit capable of executing at least one said program, for example a computer server, a computer terminal or a peripheral.

According to a second aspect, the present invention envisages a method for synchronizing sound sources, that comprises:
a control step utilizing the DLNA standard to:
   discover the audio content available on at least one DLNA server,
   configure DLNA audio renderers, one of which acts as master and each other one acts as a slave, and
   trigger the sending of content from a DLNA server to the DLNA audio renderers, using a data transfer protocol and a compressed data format,
a step of decoding the data transfer protocol by the master audio renderer,
a step of audio encoding, for the encoding by the master audio renderer of the decoded content found in a compressed audio format to an audio format with no compression and no header information,
a step of transmitting the encoded content using a protocol allowing timing control of slave systems, by the master audio renderer, and
a step of decoding and broadcasting the audio content received from the master system.

As the particular features, advantages and aims of this method are similar to those of the device that is the subject of the invention, they are not repeated here.

### BRIEF PRESENTATION OF THE FIGURES

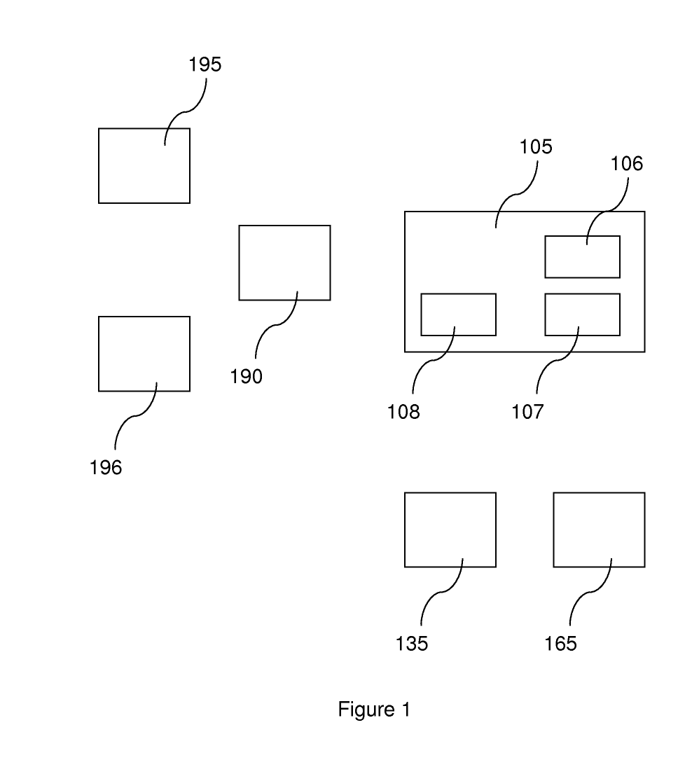

Other advantages, aims and particular features of the present invention will become apparent from the description that will follow, made, as a non-limiting example, with reference to the drawings included in an appendix, in which FIG. 1 represents, schematically, a particular embodiment of the device that is the subject of this invention.

### DESCRIPTION OF AT LEAST ONE EMBODIMENT OF THE INVENTION

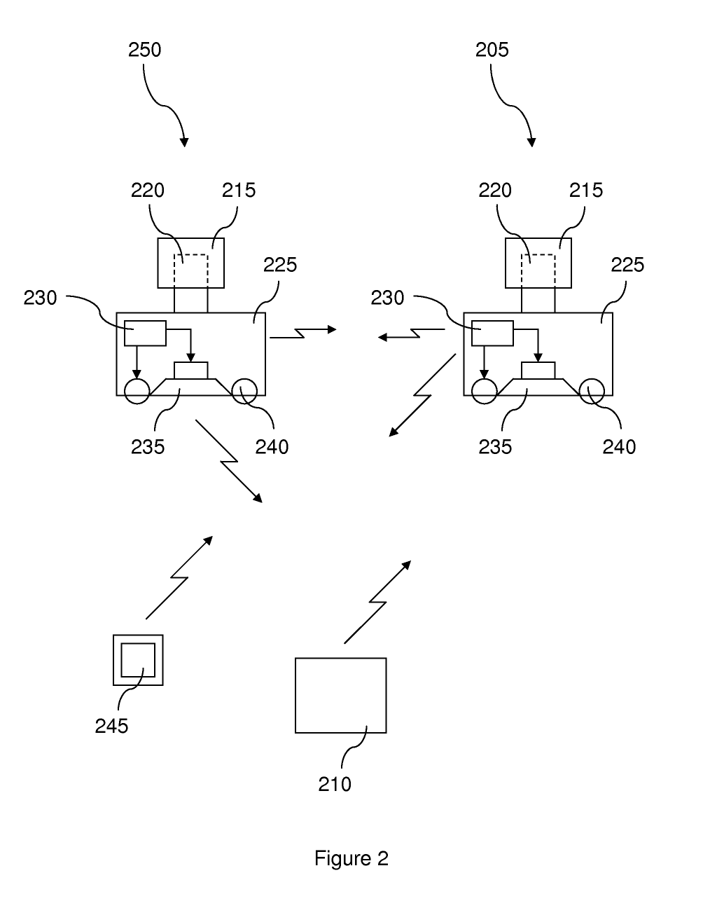

FIG. 2 shows a particular embodiment of the device 205 that is the subject of the present invention. This device 205 is mounted on an electric light-bulb socket 215 of known type, screw or bayonet, by means of a corresponding base 220, allowing it to be supplied with electricity. In a housing 225, an electronic circuit 230 comprises wireless means of communication (not shown) with:
at least one content server 210,
at least one on/off control means 245 and
another device 250, identical to device 205, but which can utilize a different operating mode (e.g. master or slave type).

The on/off control means 245 comprises, for example, a switch, a remote control, a mobile phone or a home automation control unit, or a control point as defined by either the UPnP or DLNA standards and emitting radio signals. In embodiments, the on/off control means 245 coincides with the server 210.

The housing 225 also comprises at least one electroacoustic transducer 235, for example a loudspeaker, controlled by the circuit 230. The housing 225 also comprises at least one electroluminescent transducer 240, for example of light-emitting diode or incandescent bulb type.

The electronic circuit 230 controls each electroluminescent transducer 240 depending on the switching on or off signals coming from the control means 245 and depending on the signals exchanged with the server 210 and/or the other device 250. For example, the control means 245 controls, at the user's discretion:
permanently switching on the transducers 240,
permanently switching off the transducers 240,
selecting a light intensity and/or a light color,
varying the light emitted depending on the sound signal to be broadcast by the device,
varying the light emitted in coordination with the other devices and/or
varying the light emitted depending on the sound signal to be broadcast and in coordination with the other devices.

The operation of the device 205 and of the content server 210 is described with reference to the other figures. Generally speaking, the device 205 is inserted into the network made up of similar devices and of the server 210 and synchronizes (coordinated sound and/or light emission) itself with the other similar devices.

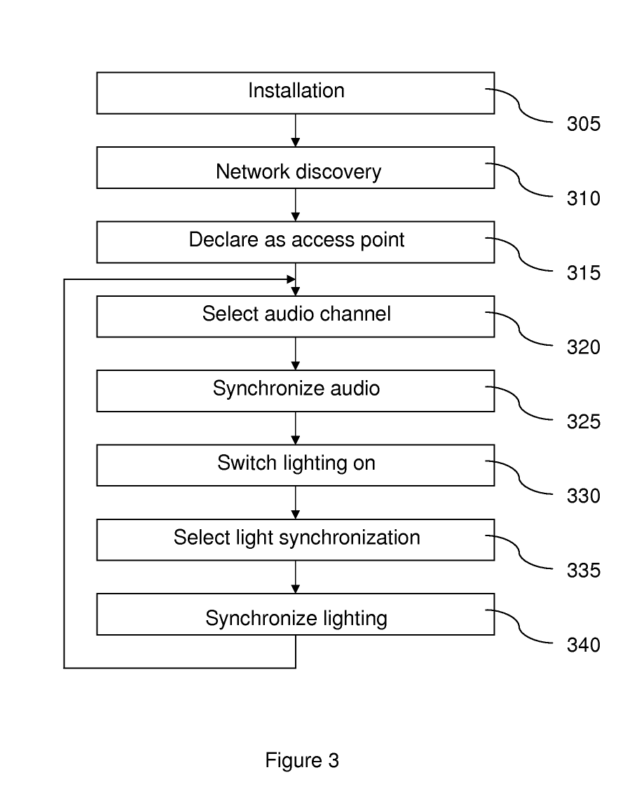

In embodiments, as shown in FIG. 3, the operation of a device that is the subject of the present invention comprises, first of all, an installation step 305. The installation consists mainly of electrically connecting the base 220 and the socket 215.

During a step 310, the device performs a network discovery, i.e. recognizing the network's components. An IP address, according to the Internet Protocol, is assigned to the device.

During a step 315, the device declares itself as being in access point mode, for example if no other access point is currently declared in the network. This mode can also be declared automatically in the network, regardless of how many other devices may be present and using this mode.

During a step 320, the device performs a selection of the audio channel that it will broadcast. This selection is performed depending on the audio channels already selected by the other devices and is communicated to the other devices. Preferably, the audio channel is selected depending on the audio channel selected by a close-by device (detected, for example, because its radio signal is received at higher strength). Possibly, if no device has selected any channel or if two devices having selected two different channels are close, the device performs an arbitration. The outcome of this arbitration is communicated to the other devices so that one of them is able to adapt to the new network configuration and to select a channel other than that which it had previously selected.

In this way, the reconfiguration of the network is dynamic and intelligent.

During a step 325, the device performs, to broadcast an audio content, a synchronization with at least one other device, as described below.

During a step 330, the device receives a command to turn on lights from the means of control 245 or from the server 210.

During a step 335, if the command received in step 330 allows this, the device selects a light synchronization mode. For example, the devices can select a light emission mode varying in intensity, color, phase, phase shift or phase inversion with the other close-by devices. The amplitude and frequency or sequence of the luminous states of the device's transducers 240 can be provided by the server 210 or programmed into at least one of the devices 205. The outcome of the selection is communicated to the other devices.

During a step 340, the selected light synchronization is utilized. In this way, psychedelic, wave, synchronized variation or, in contrast, random effects can be obtained from the set of light sources, in step or not with the sound signal to be broadcast.

Then return to step 320, the auto-configuration of each device 205 of the network being dynamic and adjusting, in particular, to the users commands by means of the control means 245.

Thanks to the utilization of the invention, a synchronization, e.g. WiFi, is automatically performed, as well as the definition of an access point. At least two digital sources synchronize themselves to define zones wherein the light and/or sound emissions are to be coordinated, for example in zones corresponding to different audio channels, left and right in particular in the case of stereophonic sound utilization.

Preferably, an IP address is managed to manage the profile, for example to manage the emitted light.

In this embodiment, the device takes the form of a light-bulb comprising a processor to react based on the presence of other similar devices and/or on the exchange of messages with other similar devices. In this way an intelligent device network is constituted.

Preferably, at least one device is able to manage itself and to manage other devices.

Examples of using the network of devices are:
the first device determines that another device, which is communicating therewith, is broadcasting the right-hand channel of a stereophonic audio signal, whereas the first device is broadcasting the left channel. More generally, it aims to equalize the number of broadcasting devices for each channel from among the devices that are in direct communication with itself (all those that respond or, if there is WiFi repetition, depending on the response time).
the device lights up with a color corresponding to the audio channel it is broadcasting.
the device changes color when another device declares changing color (all identical or, in contrast, all different), at least one of the devices changing colors on a regular basis, possibly gradually.
smart-grid to intelligently reduce power consumption or
psychedelic, i.e. changing light intensity and/or color based on the audio signal broadcast.

Thus, in embodiments, the device for broadcasting sounds for playing an audio content coming from at least one audio content server comprises:
a base for supplying electrical power to the device from a bulb socket,
an electroacoustic transducer,
a means of discovering a network comprising at least said server and at least one other device for broadcasting sounds and
a means of synchronizing the playing of sounds by said electroacoustic transducer and the playing of sounds by said other device.

Thanks to these provisions, the various sound sources are synchronized automatically, without requiring the user to perform any action other than plugging the device in an electric light bulb power supply socket.

In embodiments, the device for broadcasting sound and/or light comprises:
a base for supplying electrical power to the device from a bulb socket,
an electroacoustic transducer,
a means of exchanging messages with at least one other device for broadcasting sounds and
a means of selecting sound and/or light signals broadcast by said electroacoustic transducer, according to data received from at least one other device for broadcasting sounds.

Thanks to these provisions, the different sound sources are automatically coordinated, i.e. select a channel (right or left) of the audio content depending on the channel broadcast in addition or select a light intensity or a color of light emitted, depending on other light emissions, without requiring the user to perform any action other than plugging the device in an electric light bulb power supply socket.

In embodiments, the device for broadcasting sounds for playing an audio content coming from at least one audio content server comprises:
a base for supplying electrical power to the device from a bulb socket,
an electroacoustic transducer,
a means of declaring said device in wireless access point mode.

Thanks to these provisions, the device that is the subject of the invention makes it possible to constitute a network of devices.

Other embodiments, designed to be combined with the embodiments described above are detailed in the description that follows.

FIG. 1 shows a master system 105 and slave systems 135 and 165, audio content servers 195 and 196 and a controller 190. Servers 195 and 196 are to be understood in the sense defined by the DLNA (acronym for Digital Living Network Alliance) standard.

The DLNA association brings together companies manufacturing electronic devices, computer peripherals, personal computers, mobile telephones and service and content operators. DLNA defines an interoperability standard allowing the playing, sharing and control of multimedia devices regardless of their brand or nature. The standard identifies “actors”, some of which can be on the same equipment in the network:
the “server”, which holds the digital content and supplies same, on request,
the “renderer”, which decodes the digital content so that it can be played,
the “player”, which plays the decoded content, and
the “controller”, which makes it possible to browse through the content proposed by the servers and have it played by the renderers and players.

It is noted that the player, renderer and controller can be in a single device, which can be likened to the client in the client/server model: each compatible client (television, hi-fi system, photo frame, mobile telephone, decoder unit, etc.) can retrieve items (video, music, photos) on a DLNA server. This server can be installed on a computer or mobile telephone, or be a standalone unit with a hard disk. The network links can be via Ethernet or Wi-Fi.

DLNA is based on a number of standards, including Wi-Fi, Ethernet and MoCA for the physical layer, UPnP Device Architecture for discovery and control, UPnP AV for media management, HTTP for the transport layer, a wide range of audio, video and image format standards, and DTCP-IP for media protection during transport.

The controller 190 thus:
discovers the content,
at the user's command, configures the broadcast and the number of audio renderers, here systems 105, 135 and 165, and
triggers the sending of content from the servers 195 and 196 to the audio renderers 105, 135 and 165.

The audio renderers transmit, for example, the audio content according to the HTTP protocol (HyperText Transfer Protocol).

The master system 105 comprises an HTTP decoder 106 and an audio encoder 107, which encodes the content in a compressed audio format, e.g. MP3 or WMA, or in a RAW format (Real Audio Format), also known as PCM. It is noted here that RAW is a raw audio format, with no compression. Comparable in size to WAV or AIFF files, the RAW file contains no header information (metadata). The RAW file can be PCM, IEEE 754 or ASCII. The most common extensions are “.raw” or “.pcm”. The RAW file may have no extension.

The sound encoded by the encoder 107 is transported according to the RTP protocol (Real Time Protocol)/TCP protocol (Transmission Control Protocol) by means of a transmission module 108. This RTP/TCP protocol allows timing control of slave systems 135 and 165.

The slave systems 135 and 165 decode, with decoding modules 136 and 166 respectively, and play the audio content they receive.

Thanks to these provisions, the time offsets between the signals broadcast by the renderers are synchronized to within under 10 ms. In particular, through the use of a RAW format for audio data to be broadcast and the RTP timing control protocol, no variable delay can arise in the sound broadcasting by the master system 105 or by the slave systems 135 and 165.

It is noted that, in addition, the device that is the subject of the present invention is an open system. It is also noted that the master system 105 forms a gateway that acts as a server for the various renderers.

As is understood, a method that is the subject of the invention is a method for synchronizing sound sources, which comprises:
a control step utilizing the DLNA standard to:
   discover the audio content available on at least one DLNA server,
   configure DLNA audio renderers as access points, one of which acts as master and each other one acts as a slave, and
   trigger the sending of content from a DLNA server to the DLNA audio renderers, using a data transfer protocol and a compressed data format,
a step of decoding the data transfer protocol by the master audio renderer,
a step of audio encoding, for the encoding by the master audio renderer of the decoded content found

in a compressed audio format to an audio format with no compression and no header information,
a step of transmitting the encoded content using a real-time protocol and a transmission control protocol allowing timing control of slave systems, by the master audio renderer, and
a step of decoding and broadcasting the audio content received from the master system, simultaneously by the master and slave audio renderers.

In one of the particular embodiments (not shown), the device that is the subject of the invention comprises, in at least one renderer:
a light source base, referred to as “upstream”,
a light source powered by said base,
a socket and a downstream base between the upstream base and the light source,
a means of detecting a users movement,
a means of receiving radio signals, powered by said base, designed to receive radio signals emitted by at least one first computer system, and
a means of emitting sound signals powered by said base and designed to
retransmit radio signals received by the reception means towards a second computer system so as to extend the radio communications range between the first computer system and the second computer system, and
transmit, remotely, a signal representative of the detection of movement.

According to the present invention, “computer system” means any system equipped with a memory storing at least one program and a central processing unit capable of executing at least one said program, for example a computer server, a computer terminal or a peripheral.

The light source base, referred to as “upstream”, is of known type, e.g. screw or bayonet. The light source powered by said base is of known type, e.g. light-emitting diodes or filament.

The device that is the subject of the invention is declared as an access point in the network thus formed.

Depending on the variants, each means of receiving radio signals and means of emitting radio signals utilizes the Wi-Fi standard, Bluetooth standard, DLNA standard and/or UPnP protocol in order for the device, which forms a renderer as defined by the DLNA standard, to be discovered, as defined by this standard. In cases where the UPnP protocol is utilized, the signal emission means is designed to supply a UPnP profile for the control of the light power emitted by the light source.

The repeaters being well known to the person skilled in the art, they are not detailed here. For entering the repeaters operating parameters, e.g. its identifier (“SSID”) or a code, preferably an application on a mobile phone, e.g. of Smartphone type, or a browser operating on a computer terminal is utilized.

Preferably, the means of receiving radio signals is designed to receive signals representative of a sound signal to be emitted by the electroacoustic transducer, powered by the upstream base, and the means of emitting radio signals is designed to retransmit signals representative of said sound signal.

Preferably, the signal reception means is designed to receive signals representative of a command controlling the light power emitted by the light source, and/or the light source comprises a receiver for signals transmitted by power line communication to the upstream base.

The device that is the subject of the invention thus forms both a discrete repeater and renderers coupled to a light point, already accessible and powered. In this way, the existing sockets of a home or work-place lighting network can be used to create an extended network equipped with at least one distributed, powered repeater with no additional wiring compared to the lighting network. A large number of terminals and peripherals can communicate with a high data throughput rate.

It is also possible from a computer or a mobile phone connected to the network, equipped with a controller utilizing the DLNA standard and UPnP protocol, to discover, as defined by the DLNA standard, each of the accessible devices that are the subjects of the present invention and to control them individually or, using a grouping system, to control them by zones, ensuring synchronization over each of the zones.

In addition, a separate remote control for controlling the lighting is realized. Thus, there is no need to turn on the light source in order to broadcast a sound signal since the two subsystems are controlled independently and powered continuously. The light source can be changed like a traditional light bulb.

It is noted that some signals can be received by wireless transmission and others by wired reception.

It is possible to trigger switching on the repetition of radio signals and/or the light according to the presence of a user, or to create an alarm system, possibly with the addition of a camera and/or a microphone. Thus, in variants, a camera and/or a microphone are added to the device. The images and/or sounds captured from the detection of movement are then stored in the device or in the home automation system or transmitted remotely. Preferably, a DLNA server is then utilized for streaming (transmission in step with capture) the captured sound signal or captured images.

In particular embodiments (not shown), at least one renderer also comprises:
an electroacoustic transducer,
a means of receiving signals representative of a sound signal to be played by the electroacoustic transducer, powered by said base, and
an amplifier powered by said base and designed to amplify the electrical signal supplied by the reception means so as to transmit an amplified signal to the electroacoustic transducer.

The electroacoustic transducer is of known type, e.g. a loudspeaker. It is also noted that several miniaturized electroacoustic transducers can surround the axis of the upstream base to obtain space savings.

The means of receiving signals representative of a sound signal to be played by the electroacoustic transducer takes different forms, according to the variants. Preferably, the signal reception means utilizes the DLNA standard and UPnP protocol in order for the device, which forms a renderer as defined by the DLNA standard, to be discovered, as defined by this standard. The signal reception means is designed to receive signals representative of the sound signal to be emitted by the electroacoustic transducer by utilizing a multipoint network.

In variants, the signal reception means is designed to receive radio signals representative of the sound signal to be emitted by the electroacoustic transducer. For example, this reception of radio signals utilizes the Wi-Fi protocol or the Bluetooth specification.

In variants, the signal reception means is designed to receive by power line signals representative of the sound signal to be emitted by the electroacoustic transducer, said power line powering said light source.

The amplifier that amplifies the electrical signal supplied by the reception means so as to transmit an amplified signal to the electroacoustic transducer is of known type.

As is understood in the light of the preceding description, a discrete audio terminal coupled to a light point is utilized. One of the advantages arising from this is that, with the lighting points being numerous, accessible and powered, many sources can be positioned in a home, office, factory or store without changing the pre-existing electrical network. In this way, the existing sockets of a home's lighting network can be used to create a network of distributed, powered loudspeakers with no additional wiring. It is thus possible from a computer or a mobile phone connected to the network, equipped with a controller utilizing the DLNA standard and UPnP protocol, to discover, as defined by the DLNA standard, each of the accessible devices that are the subjects of the present invention and to control them individually or, using a grouping system, to control them by zones, ensuring synchronization over each of the zones.

The IP (“Internet Protocol”) addresses are managed in order to manage the profile, the light emission and the sound emission, in the case of the device combining these functions.

The device thus reacts according to signals supplied by other devices so as to constitute an intelligent network. For example, for playing sounds, according to the other devices' assignments to other channels, a device selects the channel (for example, right or left, in stereo or by zone in the case where several media items are broadcast in parallel in different zones) that it broadcasts. Each device sends messages over the network to indicate its role determined in this way. The device network thus converges, by successive adaptations, to an optimum configuration.

Similarly, for managing the colors of lights emitted by the devices, each device determines its color according to the color broadcast by the other devices. It is noted that different modes of operation can synchronize the colors or, in contrast, differentiate them depending on the visual effects sought. Lastly, the colors and sounds can be made dependent, as in systems called “psychedelic”. The concept of message here also includes the concepts of emitting instructions and the concepts of complying with an instruction received from another device. In another application, in order to reduce electrical consumption, the devices determine whether they should stop emitting light or sound, based on messages transmitted by the other devices and, possibly, by sensors, e.g. presence sensors.

It is noted that a device that is the subject of the invention can thus play the role of control point, renderer or server with regard to other identical devices.

In a third embodiment, in addition to the characteristics of the second embodiment, the device that is the subject of the invention comprises:
a means of controlling the amplifier designed to control the amplifier's gain, such that the sound power emitted by each of the devices that are the subject of the invention is controlled remotely and, possibly, slaved to a sensor, for example of a users position,
a sound channel selector designed to select, from several sound signals, the one that is amplified by the amplifier and played by the electroacoustic transducer, so as to broadcast one of the various sound channels, for example the right and left stereo sound over each of a plurality of electroacoustic transducers positioned in the same room, or two sound media broadcast in two different rooms, and/or
a means of controlling the light power emitted by the light source controlled by means of the signal reception means. In this way, a separate remote control for controlling the lighting is realized. Thus, there is no need to turn on the light source in order to broadcast a sound signal since the two subsystems are controlled independently.

Preferably, in order to implement this last option, the signal emission means is designed to supply a UPnP profile for the control of the light power emitted by the light source. This UPnP profile represents both the device's ability to broadcast sound signals and its ability to turn on the light source.

Preferably, for each of these embodiments, the device comprises a socket and a downstream base between the upstream base and the light source. Thus, the light source can be changed like a traditional light bulb, without modifying or replacing the components performing the functions of audio broadcasting and/or controlling the light source, which are located between the upstream base and the downstream base.

In variants, the signal reception means is designed to modulate the light emitted according to the sound signal to be played, e.g. according to an average over the last seconds. In this way, the light and music can be coordinated to produce combined effects. It is noted that it is not only the light power that can be modulated according to the sound signal but also the color, for example in the case where several light-emitting diodes emitting in different wavelength ranges are integrated into the light source.

The addition of a separate remote control and/or a “Lighting Control” UPNP profile controlling the lighting allows the upstream base to be left permanently powered. Since the lighting points are generally controlled by a switch, it would otherwise be necessary to switch on this switch in order to benefit from sound broadcasting.

It should be noted that, in itself, the creation of a hybrid profile corresponding to two profiles is an aspect of the present invention. In particular, a double profile of sound renderer and light renderer is a particular feature of this aspect of the present invention.

This third embodiment makes it possible to realize lighting control according to the music played, as a mode of operation for a musical evening, or a dance.

It is also noted that a special mode of operation of this third embodiment of the present invention comprises a simulation of presence in the premises equipped (in particular to reduce the risks of break-ins), by randomly triggering playing music and/or emitting light.

In a fourth embodiment, the device that is the subject of the invention comprises a means of detecting a users movement, the signal reception means being designed to control the amplifier according to the detection of a movement. In this way, the loudspeaker and/or light can be switched on according to the presence of a user. This fourth embodiment makes it possible for the user to continue listening to the media, e.g. the radio, which is the main benefit, while at the same time saving energy and reducing noise pollution.

Utilizing a coupling with a movement detector thus allows an automatic “follow me” (the sound broadcasting follows the user from one place to another) to be realized.

Preferably, the reception means is designed to transmit, remotely, a signal representative of the detection of movement. An alarm system is thus created, by making it possible to transmit, remotely, the movement detection information or by triggering an alarm when the user has set the home automation system to alarm mode.

In variants, a camera and/or a microphone are added to the device of the fourth embodiment. The images and/or sounds captured from the detection of movement are then stored in the device or in the home automation system or transmitted remotely. Preferably, a DLNA server is then utilized for streaming (transmission in step with capture) the sound signal or image.

Through utilization of the present invention, creating a multi-room audio system requires no wiring for the electroacoustic transducers since the existing sockets of a home's lighting network are used to create a distributed loudspeaker network. The use of DLNA/UPnP for the discovery of each of these electroacoustic transducers gives each device the role of a renderer, as defined by DLNA/UPnP, in the home automation system. It is thus possible from a computer or a mobile phone connected to the network, equipped with a DLNA/UPnP controller, to discover them and to control them individually or, using a grouping system, to control them by zones, retaining audio synchronization over each of the zones.

As described above, advanced implementations also make it possible to:
control the sound level and play the music received by each of the electroacoustic transducers,
distribute the different sound channels over each of the devices,
add a lamp to the loudspeaker and use the UPnP profiles for controlling light devices to define the light intensity of the lamp,
coordinate the light and music to produce combined effects,
add a movement control system to trigger the switching on of the loudspeaker and/or light, and/or
create an alarm system with the addition of a camera and/or a microphone

It is noted that the present invention also makes it possible to create audio-light ceiling-mounted fixtures, which allows the sound quality to be improved.

It is also noted that the particular features of the different embodiments can be combined in other embodiments to form devices having all or part of the functions described above.

1-14. (canceled)

15. A device for broadcasting sounds for playing an audio content coming from at least one audio content server, that comprises:
a base for supplying electrical power to the device from a bulb socket,
an electroacoustic transducer,
a means of discovering a network comprising at least said server and at least one other device for broadcasting sounds and
a means of synchronizing the playing of sounds by said electroacoustic transducer and the playing of sounds by said other device.

16. A device according to claim 15, that comprises:
a means of exchanging messages with at least one other device for broadcasting sounds and
a means of selecting sound and/or light signals broadcast by said electroacoustic transducer, according to data received from at least one other device for broadcasting sounds.

17. A device according to claim 16, wherein the selection means selects an audio channel according to at least one audio channel selected by another device for broadcasting sounds.

18. A device according to claim 15, that comprises a means of declaring said device in wireless access point mode.

19. A device according to claim 18, that forms a gateway that acts as a server for other devices for broadcasting sounds.

20. A device according to claim 15, that comprises
a means of receiving radio signals, powered by said base, that receives radio signals emitted by at least one first computer system, and
a means of emitting radio signals, powered by said base and that retransmits radio signals received by the reception means towards a second computer system so as to extend the radio communications range between the first computer system and the second computer system.

21. A device according to claim 15, that comprises a means of communicating at least one address of the IP Internet protocol.

22. A device according to claim 15, that comprises a means of receiving signals coming from a control point, as defined by the UPnP standard and which constitutes a renderer as defined by this standard.

23. A device according to claim 15, wherein the data transfer protocol is the HTTP protocol.

24. A device according to claim 15, wherein the audio format with no compression and no header information is the RAW or PCM protocol.

25. A device according to claim 15, wherein the transmission module that carries out encoding using the RTP real time protocol.

26. A device according to claim 15, wherein the transmission module that carries out encoding using the TCP transmission control protocol.

27. A system for synchronizing sound sources, for the playing of an audio content coming from at least one content storage system utilizing the DLNA standard, to form a DLNA server; the system comprising:
a device according to claim 15, operating in “master” mode and utilizing the DLNA standard to form a DLNA audio renderer,
at least one device according to claim 15, operating in “slave” mode and utilizing the DLNA standard to form a DLNA audio renderer,
a control means utilizing the DLNA standard to form a DLNA controller that:
discovers the audio content available on at least one DLNA server,
configures at least one DLNA audio renderer and
triggers the sending of content from a DLNA server to at least one DLNA audio renderer, using a data transfer protocol and a compressed data format.

28. A system according to claim 27, wherein the master system broadcasts the audio content simultaneously to the slave systems.
